(19) United States
(12) Patent Application Publication
(10) Pub. No.: US 2009/0276290 A1
(43) Pub. Date: Nov. 5, 2009

(54) SYSTEM AND METHOD OF OPTIMIZING COMMERCIAL REAL ESTATE TRANSACTIONS

(76) Inventor: Paul M. Sill, Chicago, IL (US)

Correspondence Address: NEAL, GERBER, & EISENBERG, SUITE 1700, 2 NORTH LASALLE STREET, CHICAGO, IL, 60602, US

(21) Appl. No.: 12/433,472

(22) Filed: Apr. 30, 2009

Related U.S. Application Data
(60) Provisional application No. 61/049,711, filed on May 1, 2008.

(51) Int. Cl. G06Q 10/00; G06F 17/30; G06N 5/02; G06Q 50/00; G06Q 30/00

(52) U.S. Cl. 705/10; 707/5; 706/52; 707/E17.018; 707/E17.017; 707/E17.044

(57) ABSTRACT

The present invention is directed to a method for facilitating a real estate transaction comprising the steps of receiving at least one site performance criteria from at least one prospective buyer, receiving prospective site data regarding at least one prospective site from at least one prospective seller, calculating the value of at least one prospective site metric using the prospective site data wherein the at least one prospective site metric corresponds to at least one of the site performance criteria, evaluating the at least one prospective site metric using a predetermined set of filtering criteria, determining whether the at least one prospective site meets the site performance criteria based on the evaluation of the prospective site data and the at least one prospective site metric and displaying the degree to which the at least one prospective site meets the site performance criteria.

### CROSS-REFERENCE TO RELATED APPLICATIONS

This application claims priority from U.S. provisional patent application No. 61/049,711, filed May 1, 2008, which is incorporated herein by reference.

### TECHNICAL FIELD

The invention relates to a system and method for optimizing commercial real estate transactions. More particularly, the present invention provides a method for determining whether a piece of commercial real estate is in an optimal location based on a predetermined set of outcome parameters.

### BACKGROUND OF THE INVENTION

There are approximately 8,500 businesses engaged in consumer-oriented retail in the United States. Approximately 4,200 of those businesses have at least 15 units and are growing at a rate of 10% or more per year according to the National Retail Federation. Approximately 60% of these firms are already engaging in some form of real estate analytics either internally or through the use of a third party firm.

While the internet and email have become essential tools, they have simultaneously created a mechanism that is overwhelming corporations with redundant and irrelevant information. The traditional commercial real estate model is inefficient, out-dated and reactive in nature. Companies receive hundreds of real estate leads monthly and must react to those lead quickly. The results are forced decisions made under difficult circumstances.

The following is an illustrative example of this problem. Company X has 26 field representatives. The company estimates that each representative receives about 60 emails per week with new sites to consider which equates to over 6,000 potential sites per month that Company X staff must evaluate collectively, the vast majority of which are redundant or irrelevant. The traditional commercial real estate model requires that each Company X representative open, print and review that site information. This presents an impossible task and an inefficient approach lacking a quantitative basis for selecting sites to pursue.

According to the National Association of Realtors, there are approximately 1.7 million licensed real estate agents in the United States. Approximately 16% of those agents engage in consumer-oriented commercial real estate, as opposed to the residential or office space sectors.

Another problem lies in the commercial real estate process from the commercial real estate agent point of view. Commercial real estate agents are overwhelmed with information and work. They are still heavily reliant on paper and offline communications and waste substantial amounts of time on administrative and non-value added tasks. Networking is a cornerstone of the industry, and with so much time spent on ancillary tasks, commercial real estate agents are in need of a reliable, efficient vehicle through which new relationships can be forged.

Therefore, it would be beneficial to create a streamlined, efficient marketplace connecting buyers of commercial real estate to sellers of commercial real estate using economic modeling to pre-screen potential properties and then facilitating a sale transaction once a suitable match is identified. Both consumer-oriented companies and commercial real estate agents would thus gain significant efficiencies and vastly greater exposure to new opportunities.

The present invention is provided to solve the problems discussed above and other problems, and to provide advantages and aspects not provided by prior systems and methods of this type. A full discussion of the features and advantages of the present invention is deferred to the following detailed description, which proceeds with reference to the accompanying drawings.

### SUMMARY OF THE INVENTION

The present invention is directed to a method for facilitating a real estate transaction comprising the steps of receiving at least one site performance criteria from at least one prospective buyer, receiving prospective site data regarding at least one prospective site from at least one prospective seller, calculating the value of at least one prospective site metric using the prospective site data wherein the at least one prospective site metric corresponds to at least one of the site performance criteria, evaluating the at least one prospective site metric using a predetermined set of filtering criteria, determining whether the at least one prospective site meets the site performance criteria based on the evaluation of the prospective site data and the at least one prospective site metric and displaying the degree to which the at least one prospective site meets the site performance criteria. The predetermined set of filtering criteria is at least partially calculated using the site performance criteria.

Another aspect of the present invention is directed to a system for facilitating a real estate transaction comprising a server for storing prospective site data regarding at least one prospective site from at least one prospective seller and for storing site performance criteria from at least one prospective buyer, a user interface allowing prospective buyers and sellers to check the status of prospective sites, a filtering module enabling evaluation of the prospective site data using a predetermined set of filtering criteria, a modeling module enabling calculation of the value of at least one prospective site metric using the prospective site data wherein the at least one prospective site metric corresponds to at least one of the site performance criteria, a scoring module enabling evaluation of the at least one prospective site metric using the predetermined set of filtering criteria and determination of whether the at least one prospective site meets the site performance criteria based on the evaluation of the prospective site data and the at least one prospective site metric and an output module enabling generation of a signal indicating the degree to which the at least one prospective site meets the site performance criteria. The predetermined set of filtering criteria comprises at least one of geographic location, proximity to at least one type of business, site size, listed price, demographic information from the surrounding area and whether the site is located within a predetermined optimal market area.

Another aspect of the present invention is directed to a method for facilitating the purchase of commercial real estate comprising the steps of inputting site performance criteria and filtering criteria, receiving prospective site data regarding at least one prospective site from at least one prospective seller, evaluating the prospective site data using the filtering criteria, receiving at least one prospective site metric based on the prospective site data, evaluating the at least one prospective site metric using the filtering criteria, receiving a determination of whether the at least one prospective site meets the site performance criteria based on the evaluation of the prospective site data and the at least one prospective site metric and determining whether to make an offer for the prospective site.

### BRIEF DESCRIPTION OF THE DRAWINGS

To understand the present invention, it will now be described by way of example, with reference to the accompanying drawings in which:

FIG. 1 is a flowchart of a commercial real estate matching algorithm embodiment of the present invention;

FIG. 2 is a flowchart of a primary market area creation algorithm embodiment of the present invention;

FIG. 3 is a flowchart of a filtering model algorithm embodiment of the present invention;

FIG. 4 is a flowchart of an analog model algorithm embodiment of the present invention;

FIG. 5 is a flowchart detailing the site loading and geocoding step of the embodiment described in FIG. 2;

FIG. 6 is a flowchart of a optimal market area creation algorithm embodiment of the present invention;

FIG. 7 is a regression sales forecast model creation algorithm embodiment of the present invention;

FIG. 8 is a flowchart of commercial real estate broker and client workflows for the embodiment of the present invention depicted in FIG. 1;

FIG. 9 is a screenshot depicting exemplary primary market area polygons;

FIG. 10 is screenshot depicting exemplary optimal market area polygons;

FIG. 11 is a screenshot depicting exemplary existing and potential commercial real estate sites for a client in a market;

FIG. 12 is a screenshot depicting the graphical result of applying an exemplary primary market area model to the potential sites depicted in FIG. 12;

FIG. 13 is a screenshot depicting the exemplary optimal market area polygons for the potential sites depicted in FIGS. 11 and 12;

FIG. 14 is a screenshot depicting a home page interface for an embodiment of the present invention;

FIG. 15 is a screenshot depicting a potential site submission form of an embodiment of the present invention;

FIG. 16 is a screenshot depicting another potential site submission form of an embodiment of the present invention;

FIG. 17 is a screenshot depicting another potential site submission form of an embodiment of the present invention;

FIG. 18 is a screenshot depicting another potential site submission form of an embodiment of the present invention;

FIG. 19 is a screenshot depicting an analysis results screen for a potential site of an embodiment of the present invention;

FIG. 20 is a screenshot depicting a client review status screen for a potential site of an embodiment of the present invention;

FIG. 21 is a screenshot depicting a listing of favorably rated potential sites for a particular client of an embodiment of the present invention.

### DETAILED DESCRIPTION OF ILLUSTRATIVE EMBODIMENTS

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Embodiments of the present invention can be implemented through software stored on a server. Generally, in terms of hardware architecture the server includes a processor and/or controller, memory, and one or more input and/or output (I/O) devices (or peripherals) that are communicatively coupled via a local interface. The local interface can be, for example, but not limited to, one or more buses or other wired or wireless connections, as is known in the art. The local interface may have additional elements, which are omitted for simplicity, such as controllers, buffers (caches), drivers, repeaters, and receivers, to enable communications. Further, the local interface may include address, control, and/or data connections to enable appropriate communications among the other computer components.

Processor/controller is a hardware device for executing software, particularly software stored in memory. Processor can be any custom made or commercially available processor, a central processing unit (CPU), an auxiliary processor among several processors associated with the server, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80x86 or Pentium series microprocessor from Intel Corporation, a PowerPC microprocessor from IBM, a Sparc microprocessor from Sun Microsystems, Inc., or a 68xxx series microprocessor from Motorola Corporation. Processor may also represent a distributed processing architecture such as, but not limited to, SQL, Smalltalk, APL, KLisp, Snobol, Developer 200, MUMPS/Magic.

Memory can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory may incorporate electronic, magnetic, optical, and/or other types of storage media. Memory can have a distributed architecture where various components are situated remote from one another, but are still accessed by processor.

The software in memory may include one or more separate programs. The separate programs comprise ordered listings of executable instructions for implementing logical functions. The software in memory includes a suitable operating system (O/S). A non-exhaustive list of examples of suitable commercially available operating systems is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system essentially controls the execution of other computer programs and provides scheduling, input-output control, file and data management, memory management, and communication control and related services.

Steps and/or elements, and/or portions thereof of the present invention may be implemented using a source program, executable program (object code), script, or any other entity comprising a set of instructions to be performed. When a source program, the program needs to be translated via a compiler, assembler, interpreter, or the like, which may or may not be included within the memory, so as to operate properly in connection with the O/S. Furthermore, the software embodying the present invention can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada.

The I/O devices may include input devices, for example but not limited to, input modules for PLCs, a keyboard, mouse, scanner, microphone, touch screens, interfaces for various medical devices, bar code readers, stylus, laser readers, radio-frequency device readers, etc. Furthermore, the I/O devices may also include output devices, for example but not limited to, output modules for PLCs, a printer, bar code printers, displays, etc. Finally, the I/O devices may further include devices that communicate both inputs and outputs, for instance but not limited to, a modulator/demodulator (modem; for accessing another device, system, or network), a radio frequency (RF) or other transceiver, a telephonic interface, a bridge, and a router.

If the server is a PC, workstation, PDA, or the like, the software in the memory may further include a basic input output system (BIOS). The BIOS is a set of essential software routines that initialize and test hardware at startup, start the O/S, and support the transfer of data among the hardware devices. The BIOS is stored in ROM so that the BIOS can be executed when the server is activated.

When the server is in operation, processor is configured to execute software stored within memory, to communicate data to and from memory, and to generally control operations of the server pursuant to the software. The present invention and the O/S, in whole or in part, but typically the latter, are read by processor, perhaps buffered within the processor, and then executed.

When the present invention is implemented in software, it should be noted that the software can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The present invention can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

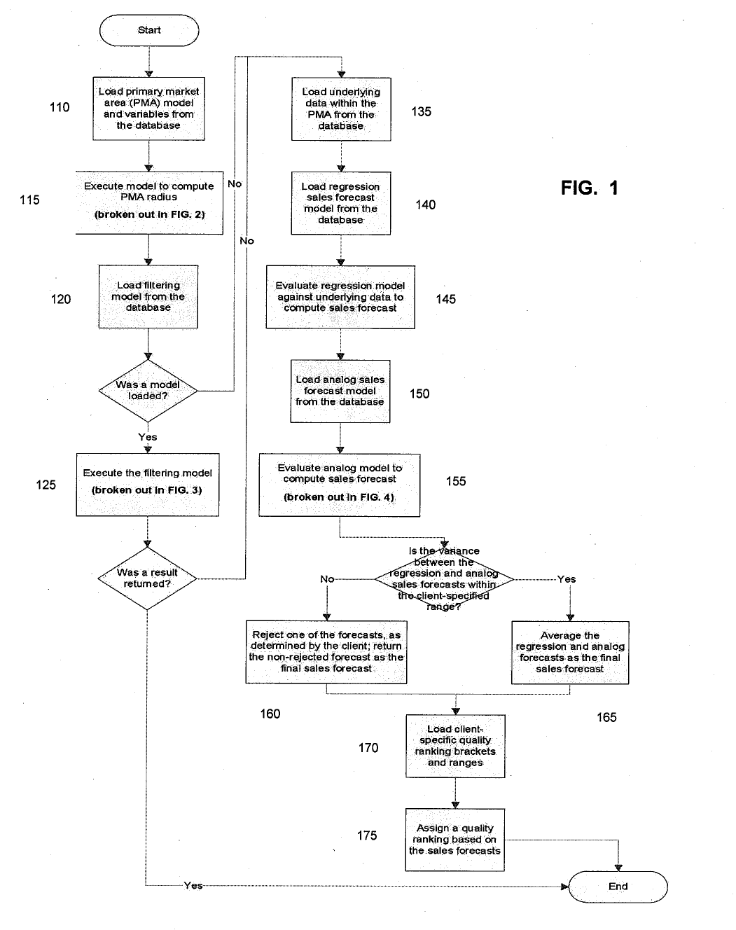

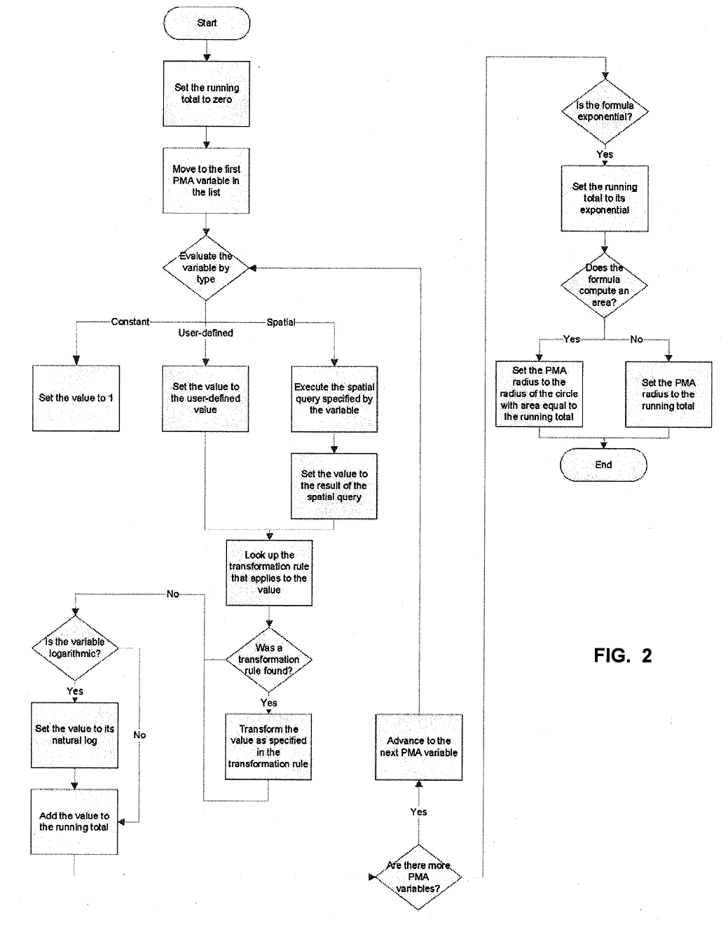

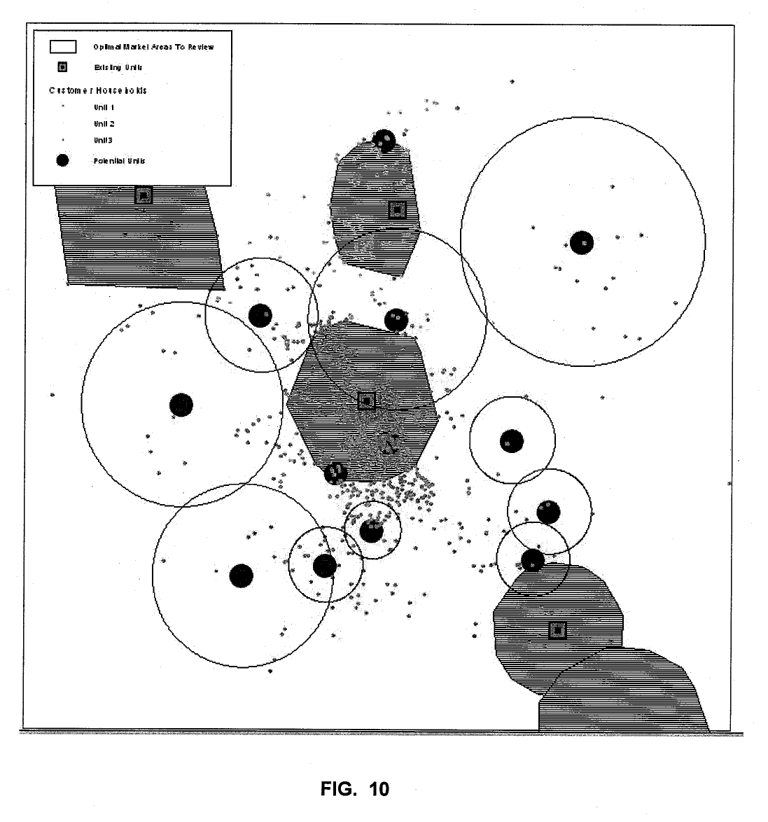

Referring now to FIG. 1, an overview of an embodiment of a commercial real estate site forecasting and matching algorithm of the present invention is shown. This process can be used to evaluate a potential commercial real estate site for a particular client or set of clients. At step 110, the relevant client primary market area (“PMA”) is loaded. A PMA uses a derived statistical model to predict estimated trade area draw for proposed new client units. At step 115, the estimated dependant variable, area of the PMA, is converted into a radius and applied around the proposed new commercial real estate site for data extraction of necessary client market data to achieve a sales forecast for that potential site. An example of this process is shown in FIG. 2. Each variable in the loaded PMA model is evaluated with respect to the potential site and assigned a corresponding value. The values can be adjusted according to the type of PMA model that was loaded and are ultimately added to a numerical running total. Once all variables have been evaluated, the running total may represent an area of a PMA circle. This area is converted to a radius used for data extraction. If the running total does not represent an area or cannot be converted to an area, the PMA radius may be set equal to the running total itself. FIG. 10 shows a graphical representation of both current client location PMAs and calculated potential site PMAs using the radius calculation described herein.

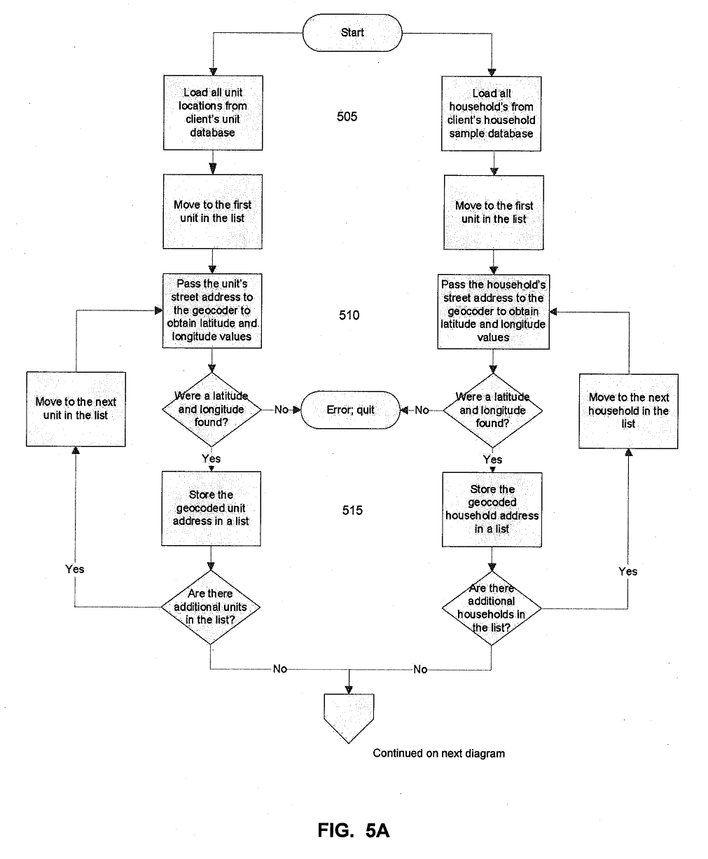

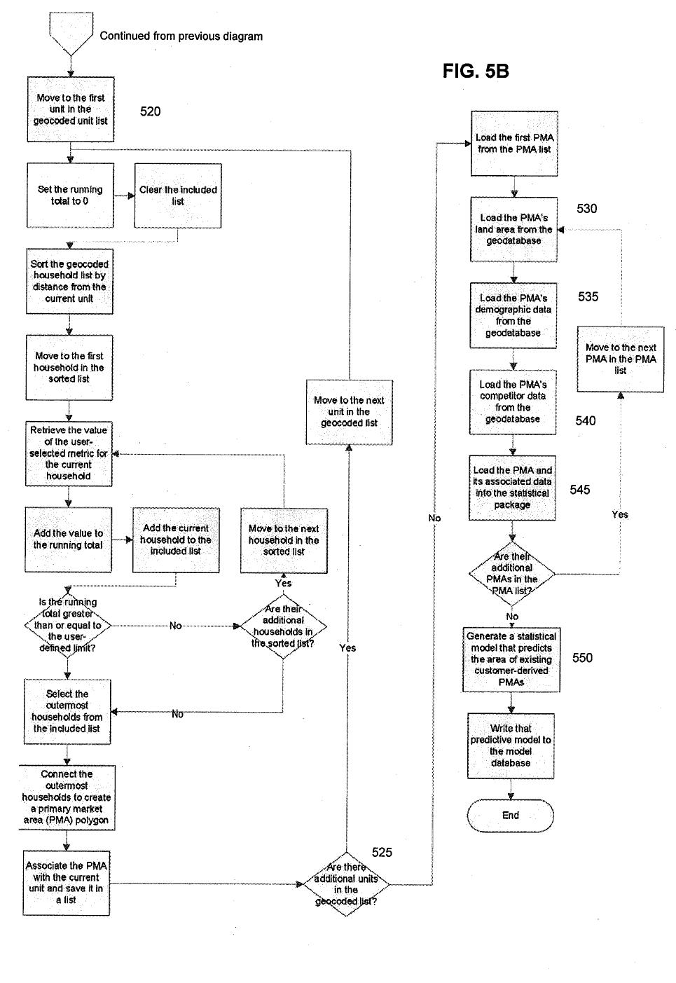

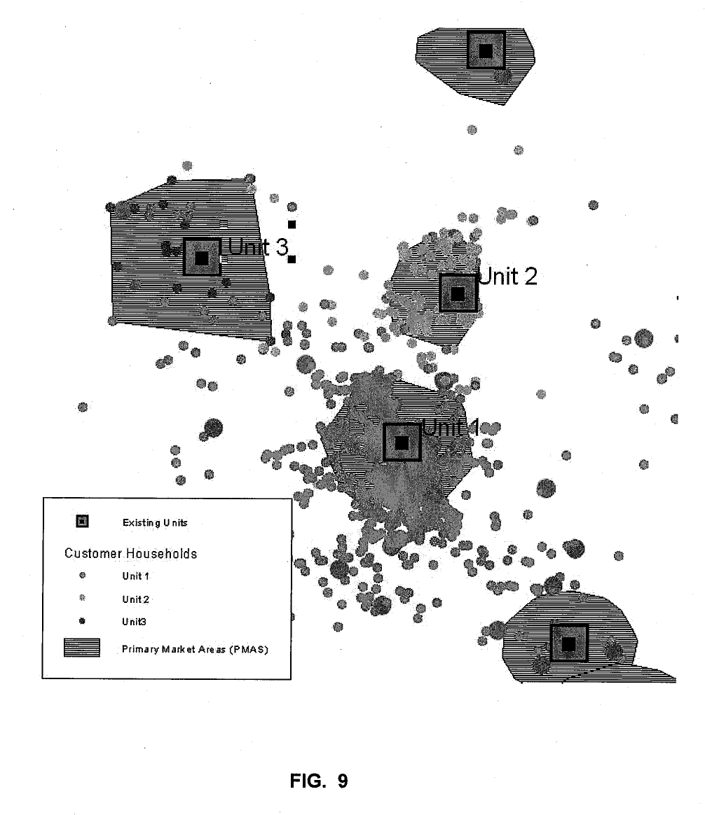

FIG. 5 shows an embodiment of a PMA model creation algorithm. At step 505, all current client locations and any known customer household locations are uploaded to the system. The street address of each uploaded location is then passed through geocoding software at 510 to obtain latitude and longitude values for each location. The geocoding software comprises a database of address and location information for a specified geographical region. These values are stored with the corresponding addresses in a list at step 515. Between steps 520 and 525, the system utilizes a convex hull computational routine of creating a polygon by connecting a fixed percentage of customer households around a current client location. The list of customer households is sorted by distance from the current client location. The iterative process begins at the household closest to the client location and collects a value for client-selected parameters for that household. That value is added to a running total. The system then moves to the next closest household and repeats these steps until the running total meets or exceeds a value predetermined by the client. On a graphical representation of all included households, a line is drawn connecting all of the outermost households to form a PMA polygon for the current client location. Examples of PMA polygons are shown in FIG. 9.

Once the PMA polygons are created the geocoding software measures the land area of each PMA polygon at step 530. At 535, the geocoding software extracts the demographic data for all households and businesses located within each PMA polygon which can include population density, household density, workplace density, size of existing client location, competition factors and drive time densities. However, one of ordinary skill in the art will recognize that many other types of data could be extracted without departing from the novel scope of the present invention. Any locations of a client competitor that fall within a PMA polygon are identified at step 540.

At step 550, the PMA polygons and corresponding extracted data are used to generate a statistical model that predicts the area of existing customer derived PMAs. For example, the PMA model equation can be a linear regression model formula Y=A(X)+B(X) . . . +b where Y equals the dependant variable, or the area of the trade area that is computed, A, B, . . . equal the independent variable(s) such as population density and (X) equals the regression coefficient determined through the linear modeling process. This represents the weight, or strength of this independent factor in driving the value for Y. b is the model constant as determined through the linear modeling process.

An example customer PMA model might look like this: A(population density or 50,000)*((X) 0.22565 as the coefficient))+b (the constant of 1.2)=Y which is the area of the predicted trade area radius to encompass, in this example 11,283.7 which when converted into a radius using the formula: Radius=the square root of (area/pi, which is 3.14). In this example, the trade area radius computed would have been 59.9461 miles. Again computed as taking the square root of our area of 11,283.7 divided by 3.14 which is the pi estimate.

Returning to FIG. 1, after the PMA model has been executed and a PMA radius has been calculated for a potential commercial real estate site, a filtering model is loaded at step 120 and executed at step 125. This model allows clients to quickly pre-screen potential sites before executing computationally intensive forecasting. The filter model can be essentially comprised of a series of pass/fail tests for a potential commercial site. If the potential site meets a specified condition, then it continues through the filtering model and into the forecasting sections of the matching algorithm. However, if a potential site fails to meet a specified condition, the system stops the evaluation process and immediately assigns the site a “poor” rating. The various aspects of a filtering model are not necessary to all client business models, can be client specific and can be customized accordingly.

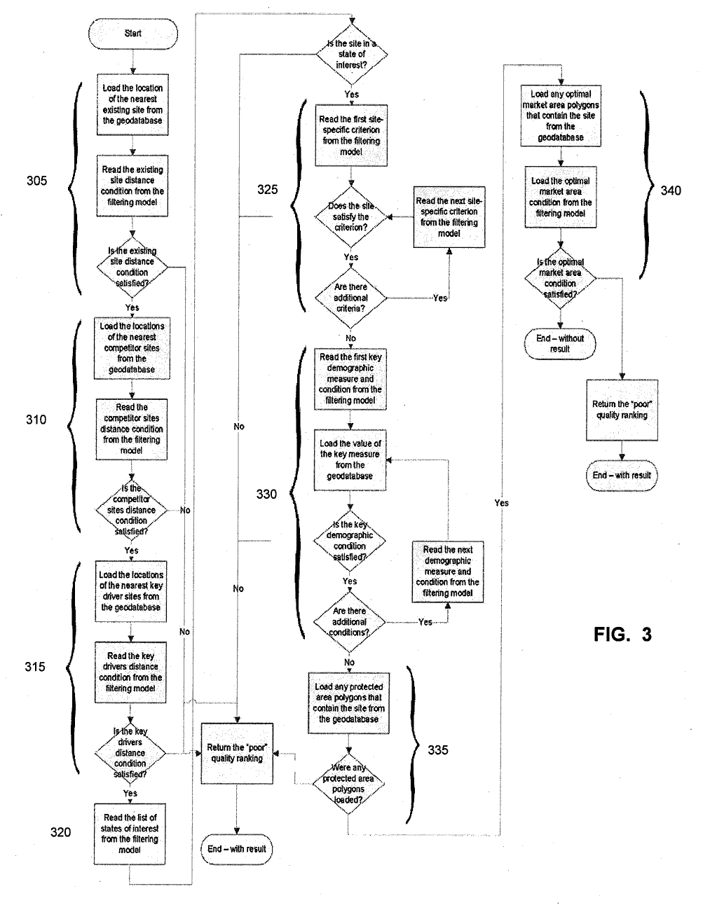

FIG. 3 shown an embodiment of filtering model implementation. At step 305, the distance of the potential site to the next nearest current client location is calculated using latitude and longitude to determine if it is greater or less than a client predetermined threshold distance. At step 310, the distance between the potential site and a set of predefined competitor locations is calculated to determine if it is greater or less than a client predetermined threshold distance. At step 315, the system calculates the distance between the potential site and a set of predefined key market drivers such as big box retailers, major grocery stores, government buildings, sport stadiums, colleges, local schools and other predetermined critical market factors to determine if it is greater or less than a client predetermined threshold distance.

The system then determines if the state in which the potential site is located is a geographic area of interest for the client at step 320. At step 325, the system evaluates any custom client criteria with respect to the potential site. At step 330, basic demographic measurements are taken for the potential site to determine if key demographics such as average household income within half a mile of the potential site or total population within half a mile of the potential site meet a client's predetermined threshold. At step 335, the system determines if a potential site is located within a client-determined protected geographical area. This step utilizes a predetermined set of geography polygons that represent contractually protected areas for franchisors and franchisees. A point in the polygon geographic request can be utilized to determine whether the proposed site meets or fails this predetermined criteria.

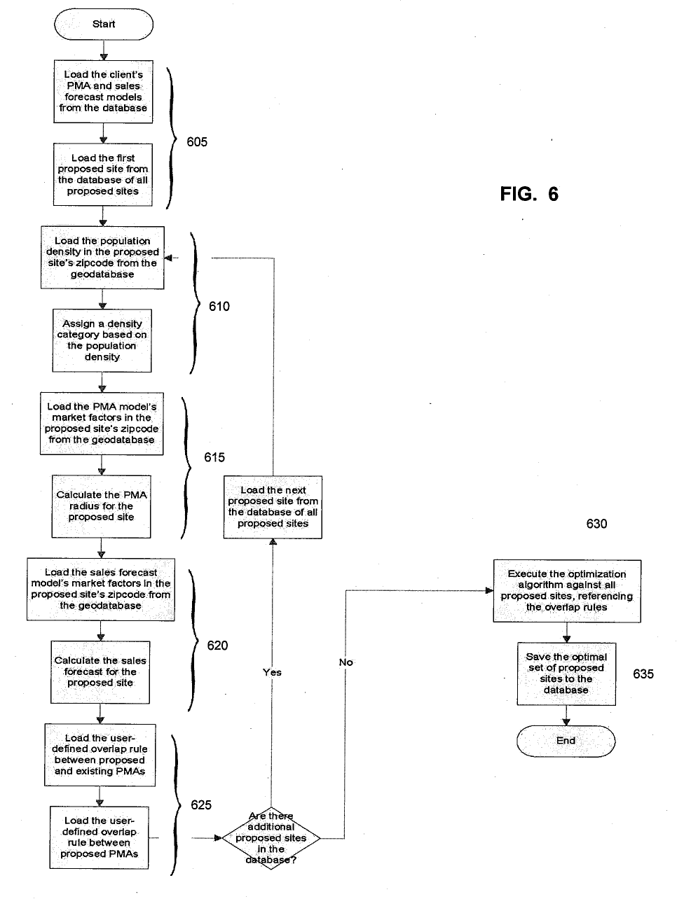

Finally, at step 340, the system determines whether a potential site is inside or outside of a pre-determined set of client Optimal Market Areas. Optimal Market Areas are geographical polygons derived for a specific client based on certain input parameters. FIG. 6 shows an embodiment of an Optimal Market Area creation algorithm. First, at step 605, the system accesses and loads the client's PMA model and the proposed site database for an entire geographical region the client desires to calculate Optimal Market Areas for. This may consist of sites submitted by a broker or could entail the use of surrogate site points such as geographic centroids of zipcodes, population weighted centroids of zipcodes, census tracts, census block groups, neighborhood centroids or any other database of latitude and longitude coordinates that represents potential sites for real estate development. At step 610, the latitude and longitude of each potential new site are used to compute a density score classifying each potential site as either urban, suburban, rural, super rural or central business district based on a predetermined criteria set up by the client. Density is determined based on the density of the zipcode in which the potential site is located.

Then, at step 615, the necessary market factor data to execute the client's PMA model is extracted from the zipcode for each potential site and the PMA model is executed for each potential site. At step 620, the system computes a sales potential forecast for each potential site using a statistical model based on client predetermined values and data extracted from each potential site PMA such as number of households, competitors and key market drivers.

Step 625 allows a client to set two trade area overlap thresholds as rules for an optimization of the proposed available market areas. Rule 1 is an overlap allowance for proposed new market areas to existing unit market areas. For example, the client may determine that it does not want any proposed new market areas to infringe upon an existing client location's primary market area by more than 20%. As a result, all proposed market areas overlapping existing market areas by more than that extent would be eliminated during the optimization routine. Rule 2 is an overlap allowance of proposed new market areas to other proposed new market areas. This overlap allowance is a surrogate for market saturation preferences for the client. For example, client may determine that they do not want a proposed market area to overlap any other proposed market area by more than 20%. In doing so they are limiting the number of proposed available market areas that will be made available to them in that market and over proposed market areas exceeding this threshold would be eliminated in order of least to most value.

Ultimately, the sales forecast and PMA areas for each potential site can be fed into the optimization algorithm, which is executed for each potential site at step 635. This routine automates the process of retaining the set of proposed new market areas that simultaneously maximize the sales potential of a given geographic area in terms of potential for the client, but also meets all of the clients overlap allowances. The balance this process creates is a geographic area in which all exiting units can most effectively coexist with new units, and new units will maximize the market potential of that area and minimize the risk of excessive sales cannibalization of other existing units. The optimization algorithm also mitigates the risk of competitors entering a market and occupying optimal areas ahead of the client. Further, the optimization provides the client an optimal road map for the development of a given geographic area. This statistical model is similar to the one used for the PMA model determination. However, rather than using the area of the trade area as the model dependant factor, the same data that is extracted for each existing trade area polygon is modeled against store sales for a particular company.

For example, assume a client had 100 stores. Each store PMA would be created using the process detailed above. For each of those existing PMAs a pre-determined set of demographic variables would be extracted such as household, incomes, ages, housing values and growth of market. For each of the 100 existing stores, distances to nearest competitors, other existing units, and other key market factors such as major malls, colleges and interstates could be computed as well, as an additional set of independent variables to test in the modeling process. Additional data for these 100 existing stores such as store quality, advertising effectiveness, brand strength, quality of service and age of store could also be collected for modeling as independent factors. The result is a complex linear regression model that works similar to the PMA forecasting model, but usually more robust.

The equation for this example would be as follows: Sales at a store=(high income*a weight)+(population growth*weight)+(distance to a competitor*weight)+(distance to a college*weight). The weights are determined by the client according to the characteristics of its particular business model. This is similar to the PMA model formula, but includes different factors determined for the purpose for forecasting sales as opposed to trade area draw. This model is utilized and executed for the optimization processing algorithm which first is run on a point to determine the trade area draw using the PMA model, then extracts and computes the data needed to execute the sales forecasting model for that point and proposed trade area. This sales prediction value is then used as the sorting value in the algorithm.

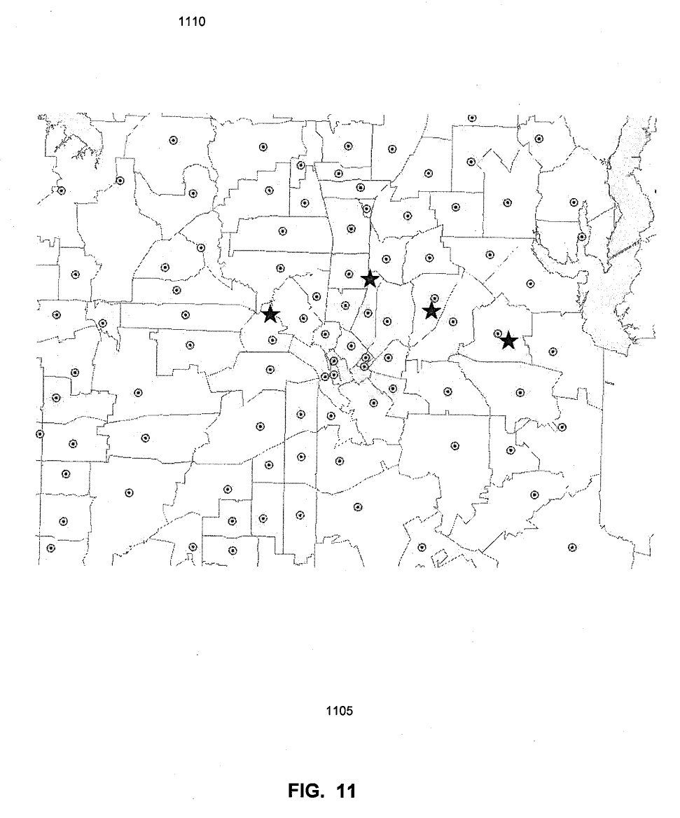

FIGS. 11-13 illustrate the optimization process. In FIG. 11, an existing market is shown. The stars 1105 represent existing stores for client X. The rings around those stars 1105 represent existing trade areas which need to be protected, meaning new potential store trade areas, or sites, can not fall within those rings and cannot overlap those rings by more than the pre-determined amount set by the client. The circles 1110 represent 119 potential real estate locations that this client might consider for expansion.

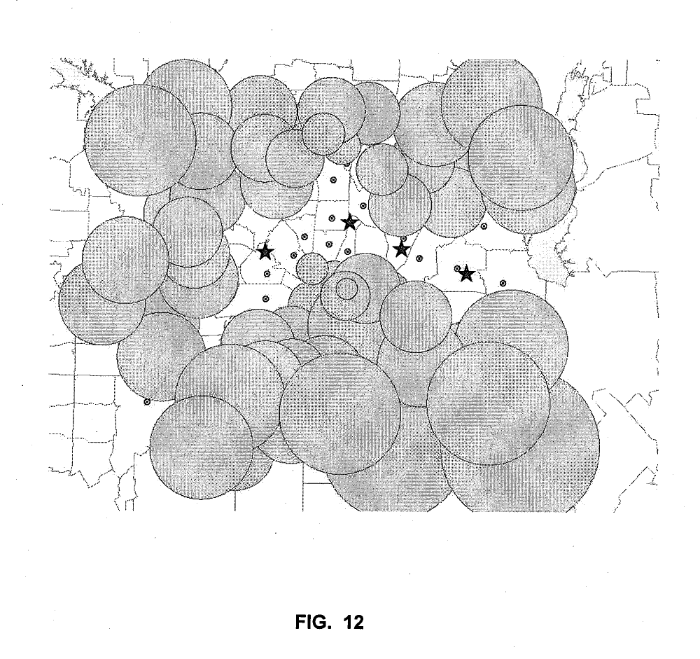

FIG. 12 shows a graphical representation of when the PMA model has been applied to all 119 potential blue dot sites. The result is 119 heavily overlapping potential trade area rings derived from the PMA model built for the client. As outlined above, the 119 potential rings are processed as follows: (1) the necessary underlying demographic data is being extracted for each ring; (2) the necessary distances are being calculated from the center of each ring, the potential site, to each competitor location and each existing Client X location; (3) a sales forecast is being determined for each ring based on the linear sales potential model created for Client X as described in section above; (4) each of the 119 sales forecasts, for each ring, are then rank ordered from highest to lowest in a virtual table; (5) the overlap percentage of the proposed PMA ring is computed against the Client X existing trade area rings to determine which of these proposed rings overlaps an existing trade area by more than the user defined allowable extent (those sites and their rings are eliminated); (6) the overlap of each potential ring, to every other potential ring is then also computed and will be used to further eliminate rings from the remaining subset of available potential rings but cross checked against the user defined criteria for allowable overlap with themselves; and (7) the algorithm is also searching for the HIGHEST sales potential rings to retain that meet BOTH of these overlap criteria and will ultimately retain only the rings that first meet the overlap criteria, but then secondly have the highest sales potential in aggregate for Client X.

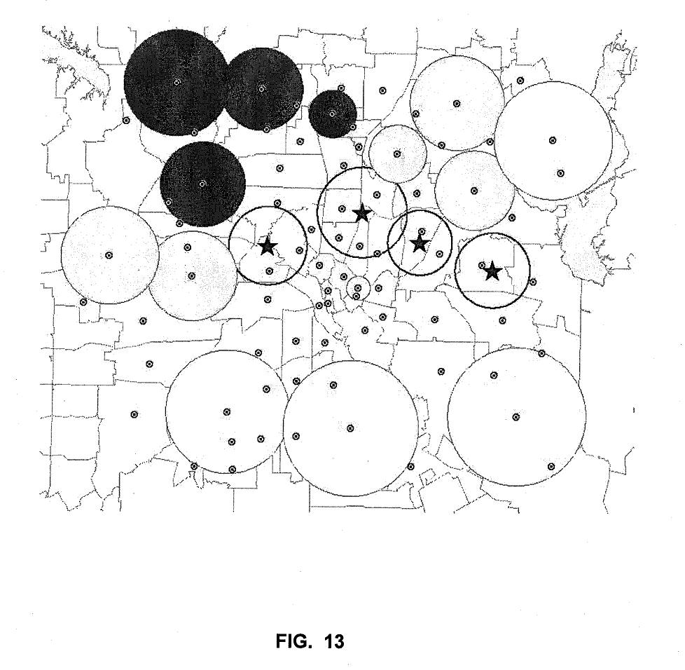

FIG. 13 shows the end result. All 119 potential sites are shown, but the routine has retained only 22 of the 119, in effect filtering our 82% of the potential sites to identify only the best 22 that meet the overlap criteria setup by the client and have the highest sales potential possible. In this image, the rings that remained are color-coded by sales potential from high (darker) to low (lighter) sales potential. None of the potential rings overlap the existing client trade areas by more than 20%. None of the potential green rings remaining overlap each other by more than the exemplary 20% allowance set in this embodiment. Thus, using this process, a national set of Optimal Market Areas can be derived for a client. Once a set of Optimal Market Areas is created, it is saved to a database in step 635.

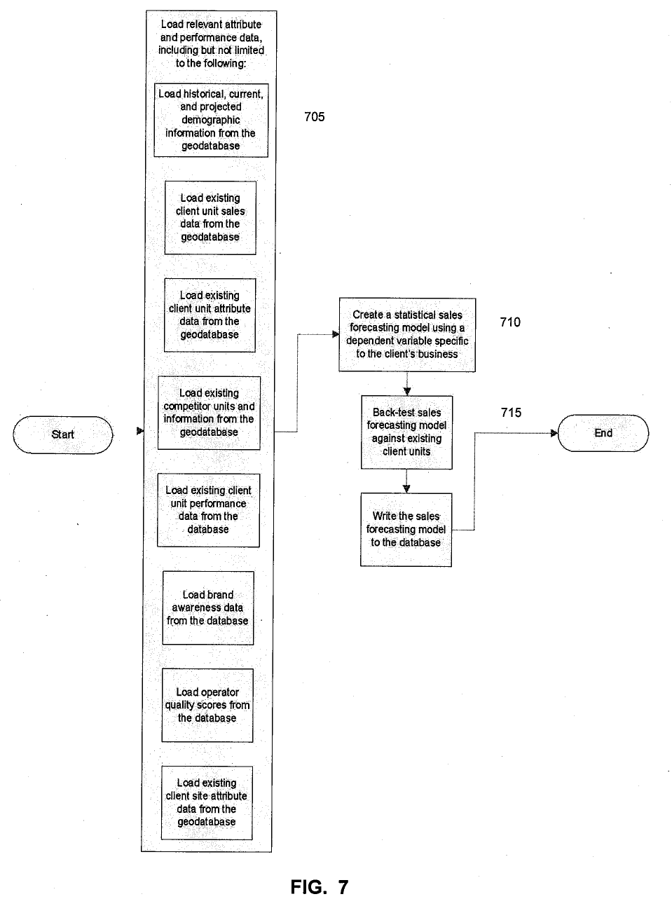

Again returning to FIG. 1, once a potential site has passed through the filtering model, the system loads underlying PMA data for the potential site at step 135, loads a regression sales forecast model at step 140 and executes the sales forecast model for the potential site at step 145. A regression sales forecast model is a statistically derived sales model uniquely created for a specific client. In FIG. 7, an embodiment of a regression sales forecast model creation algorithm is shown. Initially, at step 705, the system collects relevant data from a sample of existing client locations, field resources or third party vendors. The data collected can include: census based and estimated demographics for current, prior, and future years; existing client units and sales data for some time frame; existing client unit attribute data such as size of unit, age of unit, format of unit, menu selection, design, layout; competitive information about key client competitors and their size, age, format and location; existing unit performance data such as mystery shopping scores, customer satisfaction score, advertising expenditures; brand awareness measurements for the client and their brands are computed or collected; operator quality scores are computed or collected on managers, franchisees; and site specific attribute data is collected or provided on elements such as visibility, accessibility, signage, parking, adjacencies, and other site attributes.

From this data, a statistical sales potential forecasting model is created at step 710 using a dependant variable specific to each client's business, such as sales, market share, profit, or market potential. Those of ordinary skill in the art will understand that a wide array of dependent variables could be selected without departing from the novel scope of the present invention. At step 715, the sales model is applied to all exiting client units, tested against hold out sample and analyzed for accuracy and relevance to the client's purposes.

Eventually at step 145, the sales model is applied to the data extracted from the PMA model for a proposed new site to determine sales potential for the client and priority of the site for client's development effort. A sample sales model for Client X might present as shown below in Table 1.

TABLE 1
Application of Illustrative Sales Model to Client X

| Variable Name | (A) Value | (B) Value | Subtotal (A * B) |
|---|---|---|---|
| Constant | — | 2.7532 | 2.7532 |
| Site Attribute 1 | 1,000 | 0.0545 | 3.9982 |
| Competitive | 5 | 0.2488 | 0.2183 |
| Attribute 1 | | | |
| Market Attribute 1 | 125,000 | 0.0238 | 7.9980 |
| Market Attribute 1 | 5.4 | 0.223 | 0.1858 |
| | | Sum of above | 15.1535 |
| | | logged values | |
| | | Sales Forecast | $3,811,554 |
| | | (exp) | |

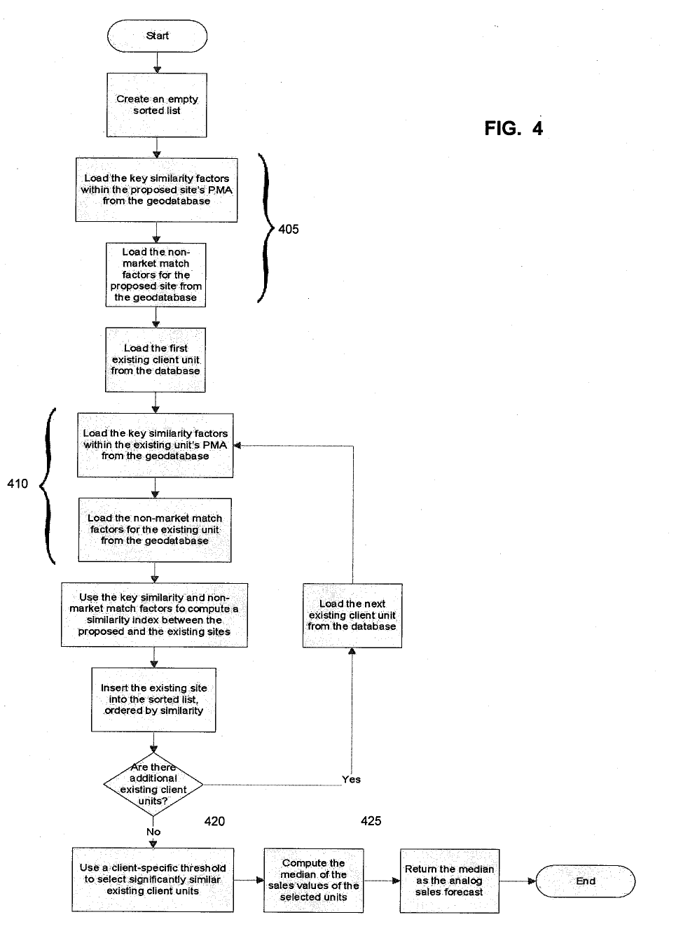

After the application of the sales model forecasting, the system loads an analog forecasting model at step 150 and applies this model to the potential site at step 155. The analog model simply can provide a second forecast to the client for a more robust profile of a potential site. FIG. 4 shows an embodiment of an analog model application. At step 405, the system loads key similarity factors and non-market match factors for a potential site's PMA. Key similarity factors may include income, households, workplace population and age of population. Non-market match factors may include distance to competitors, number of competitors in a given radius, size of unit and type of unit. In step 410, the system loads the corresponding factors for the current client location.

The system executes the analog routine in step 415 to compute a match quality of the potential site and PMA to the highest matched current client locations. A match quality is determined by a “confidence level” or “similarity score.” A confidence level or similarity score indicates a weighted sum total of how well current client location selected to generate a sales forecast matched the five key factors of the potential site. The sum is weighted because for each of the five factors, a Similarity Score is calculated. Each of the individual scores are then weighted and summed to obtain a final Similarity Score for a potential site.

For example, a potential site has the attributes shown in Table 2 below.

TABLE 2
Attributes of Exemplary Potential Site

| Factor | Value |
|---|---|
| Demographic 1 | 1,100 |
| Site Attribute 1 | 10,000 |
| Competitive Attribute 1 | 2 |
| Market Attribute 1 | 40,000 |

Table 3 shows how an analog model would assess the Confidence or Similarity of two current client locations and the potential site described in Table 2.

TABLE 3
Exemplary Application of Analog Model

| | | Difference to | % Similiarity on This | Variable | Final |
|---|---|---|---|---|---|
| Factor | Existing Unit | Proposed | Factor | Weight | Calulation |
| Demographic 1 | 1,500 | (1,500 − 1000) = 500 | (1 − (500/1000) = 50% | 35% | 50% * 35% = |
| | | | | | 0.175 |
| Site Attribute 1 | 9,000 | (10,000 − 9,000) = 1,000 | (1 − (1,000/10,000) = | 30% | 90% * 30% = |
| | | | 90% | | 0.27 |
| Competitive | 2.1 | (2.1 − 2.0) = 0.1 | (1 − (0.1/2.0) = 95% | 20% | 95% * 20% = |
| Attribute 1 | | | | | 0.19 |
| Market | 44,000 | (44,000 − 40,000) = | (1 − (4,000/40,000) = | 15% | 90% * 15% = |
| Attribute 1 | | 4,000 | 90% | | 0.135 |
| | | | | | 77% |
| Demographic 1 | 1,100 | (1,100 − 1,000) = 100 | (1 − (100/1,000) = 90% | 35% | 90% * 35% = |
| | | | | | 0.315 |
| Site Attribute 1 | 8,000 | (10,000 − 8,000) = 2,000 | (1 − (2,000/10,000) = | 30% | 80% * 30% = |
| | | | 80% | | 0.24 |
| Competitive | 2 | (2 − 2) = 0.0 | (1 − (0.0/2.0) = 100% | 20% | 100% * |
| Attribute 1 | | | | | 20% = 0.20 |
| Market | 42,000 | (42,000 − 40,000) = | (1 − (2,000/40,000) = | 15% | 95% * 15% = |
| Attribute 1 | | 2,000 | 95% | | 0.1425 |
| | | | | | 90% |

In a weighted analog model, at step 420, the client can have the ability to decide if a 77% similarity is worth keeping in a sales forecast by setting the Confidence Threshold prior to running the analysis. In this embodiment, the default Confidence Threshold is 80%, as a result, the first store would not have been included as an analog match in the final sales forecast for this proposed site. Whereas, the 90% overall similar store would be a strong match and make for a good addition to any final sales forecast. At step 425, the system takes the median of the sales values or the client's pre-determined value metric for the highest matching analog stores and uses them as a cross check for comparison to the statistically derived sales potential forecast for similarities.

Again referring to FIG. 1, after the analog model is executed, the system determines whether any variance between the forecasts from the regression model and analog model is within a client predetermined range. If no, then at step 160 the system rejects one of the forecasts as directed by the client and uses only the non-rejected forecast. If yes, then at step 165 the system averages the two forecasts together. Finally, at steps 170 and 175 client-determined sales potential brackets are used to classify the potential site as an “excellent,” “good,” “fair” or “poor” match for the current real estate needs based on the sales forecast value.

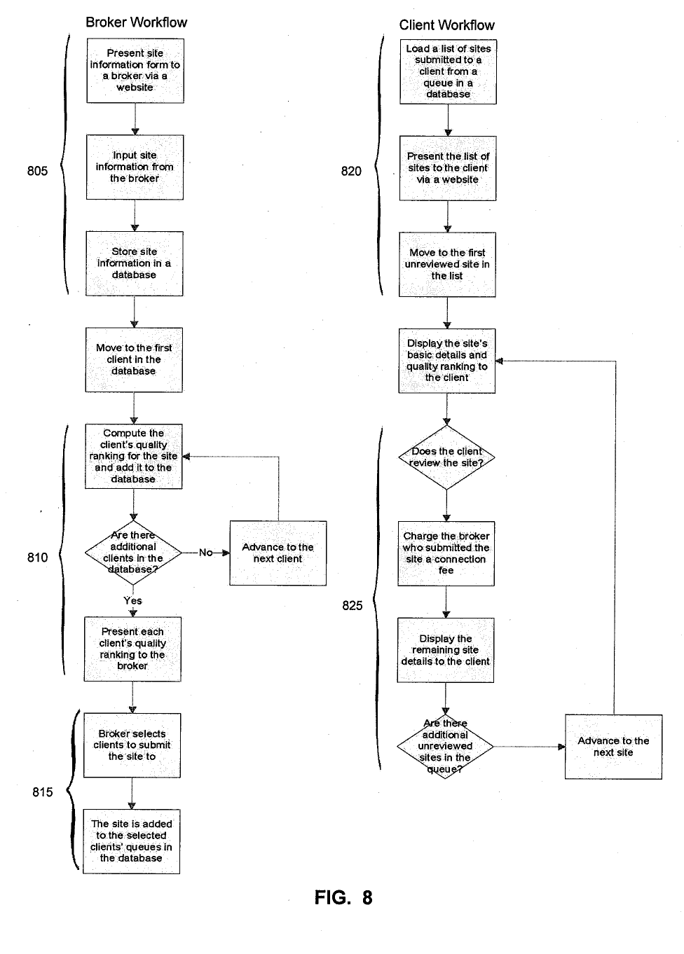

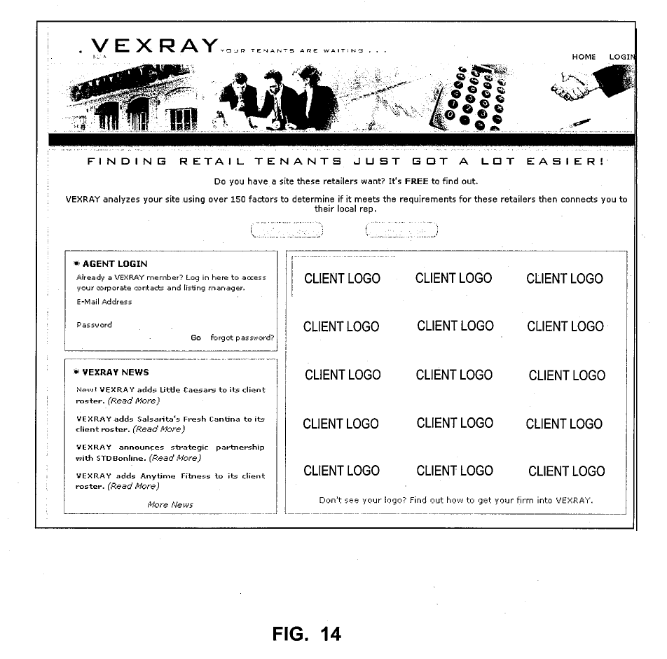

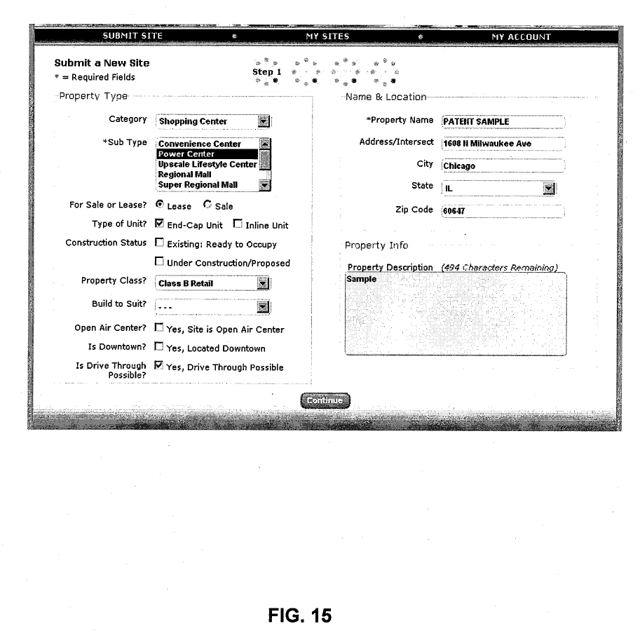

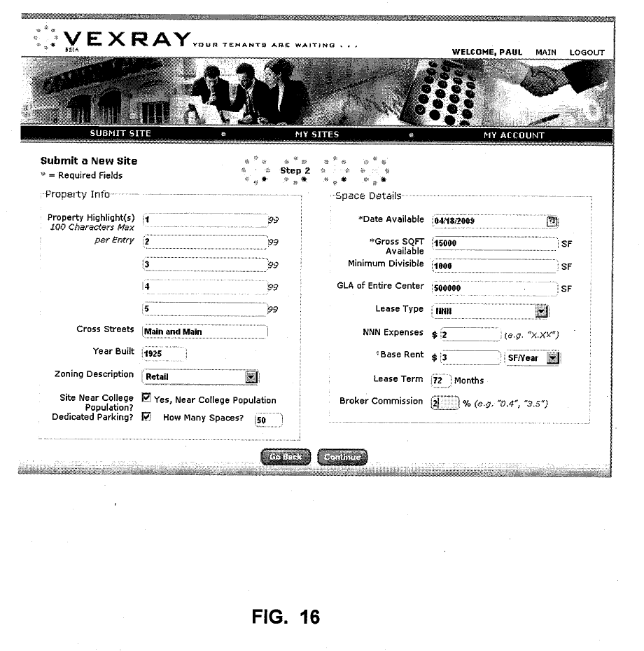

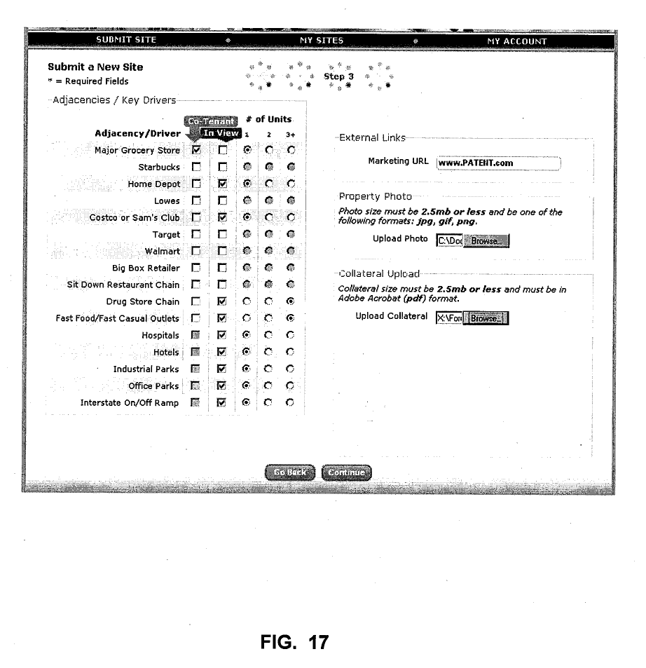

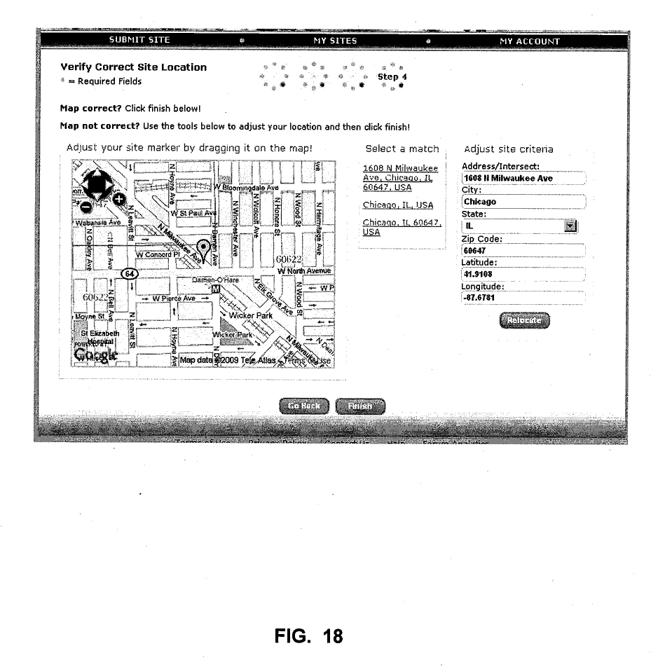

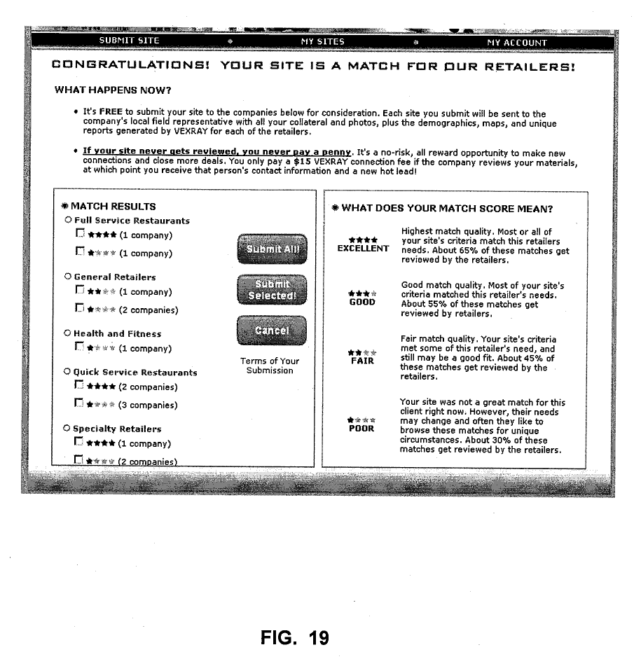

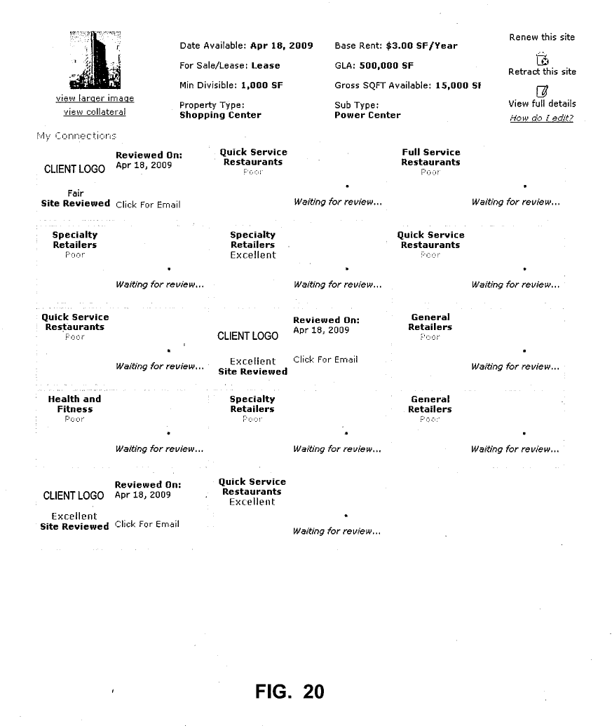

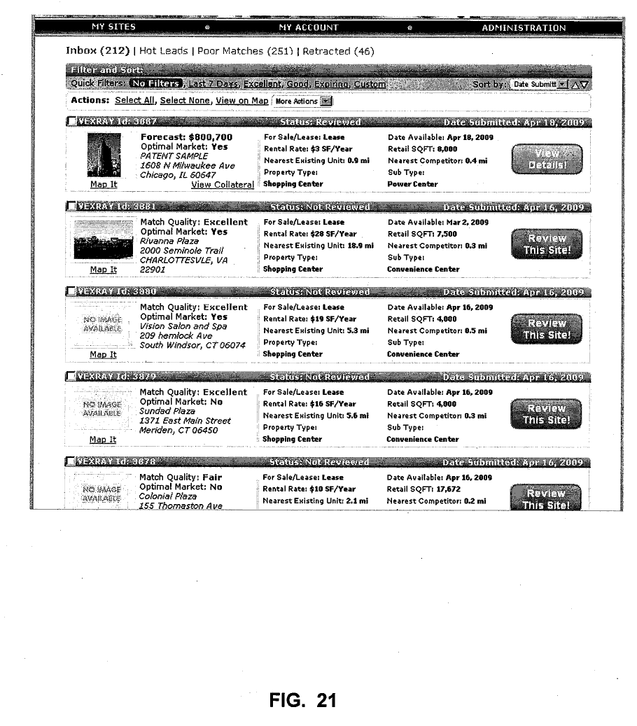

Referring now to FIG. 8, real estate broker and client workflows for an embodiment of the present invention are shown. On the broker side, at step 805, a real estate broker listing a potential site can access the system via a website and upload various data regarding the potential site including geographic location as shown in FIGS. 14-18, which is ultimately stored in a database. At step 810, the potential site undergoes various modeling and rating as described above and a rating of the potential site is returned to the broker as shown in FIG. 19. Lastly, at step 815 the broker can decide whether to submit the potential site to a client reviewing queue. If the site is submitted that system will update the broker regarding which clients have reviewed the site as shown in FIG. 20. On the client side, at step 820, a queue of submitted potential sites is loaded via a website for the client to browse giving basic details regarding each potential site as shown in FIG. 21. At step 825, the client can decide to review a particular site more thoroughly which yields greater detailed information about the site and also a charge to the client's account. If a client determines that a reviewed site meets its needs, then the system facilitates contact with the potential site's broker to begin a sale transaction.

Any process descriptions or blocks in figures represented in the figures should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While the specific embodiments have been illustrated and described, numerous modifications come to mind without significantly departing from the spirit of the invention, and the scope of protection is only limited by the scope of the accompanying Claims.

What is claimed is:

1. A method for facilitating a real estate transaction comprising the steps of:
receiving at least one site performance criteria from at least one prospective buyer;
receiving prospective site data regarding at least one prospective site from at least one prospective seller;
calculating the value of at least one prospective site metric using the prospective site data wherein the at least one prospective site metric corresponds to at least one of the site performance criteria;
evaluating the at least one prospective site metric using a predetermined set of filtering criteria;
determining whether the at least one prospective site meets the site performance criteria based on the evaluation of the prospective site data and the at least one prospective site metric; and
displaying the degree to which the at least one prospective site meets the site performance criteria.

2. The method of claim 1 further comprising the step of screening the prospective site data using the predetermined set of filtering criteria.

3. The method of claim 1 wherein the predetermined set of filtering criteria is comprised of the site performance criteria.

4. The method of claim 1 wherein the predetermined set of filtering criteria is at least partially calculated using the site performance criteria.

5. The method of claim 1 wherein the site performance criteria comprises at least one of sales, market share, profit and market potential.

6. The method of claim 1 wherein the predetermined set of filtering criteria comprises at least one of geographic location, proximity to at least one type of business, site size, listed price, demographic information from the surrounding area and whether the site is located within a predetermined optimal market area.

7. The method of claim 1 wherein the calculating of at least one prospective site metric comprises the steps of deriving a primary market area for the prospective site, extracting consumer data from within the prospective site primary market area and using the extracted data to calculate the prospective site metric.

8. The method of claim 7 wherein deriving a primary market area for the prospective site comprises the steps of creating a primary market polygon for each existing prospective buyer location, computing the land area of each primary market polygon and generating a statistical model that predicts the area of a primary market polygon based on the computed land areas.

9. The method of claim 8 wherein the statistical model is generated using linear regression modeling.

10. The method of claim 8 wherein creating a primary market polygon is comprised of the steps of receiving client customer household data for an existing prospective buyer store, geocoding existing customer household data to obtain address-level latitude and longitude coordinate for existing customers and creating a polygon connecting a predetermined percentage of customer household locations around the existing prospective buyer location.

11. The method of claim 10 wherein the polygon connecting a predetermined percentage of customer household locations around the existing prospective buyer location is created by a convex hull computational routine.

12. The method of claim 7 wherein the prospective site metric is tabulated using a statistically derived model based on attributes of existing prospective buyer locations.

13. The method of claim 12 wherein the attributes of existing prospective buyer locations comprise size, age, format, design, layout, proximity to competitors, mystery shopping score, customer satisfaction score, advertising expenditures, brand awareness, operator quality, visibility and available consumer amenities.

14. The method of claim 7 wherein tabulating the prospective site metric comprises the steps of determining a set of key similarity factors based on existing prospective buyer locations, computing non-market factors, extracting key similarity factor data from the prospective site and existing prospective buyer locations, comparing the prospective site and existing prospective buyer site data for each key factor and assigning a similarity score based upon the data comparison.

15. The method of claim 14 wherein key similarity factors comprise at least one of income, households, workplace population and age of population for each existing prospective buyer location's primary market area.

16. The method of claim 14 wherein non-market factors comprise at least one of the number of competitors in the primary market area, size of prospective site and type of prospective site.

17. A system for facilitating a real estate transaction comprising:
a server for storing prospective site data regarding at least one prospective site from at least one prospective seller and for storing site performance criteria from at least one prospective buyer;
a user interface allowing prospective buyers and sellers to check the status of prospective sites; and
a filtering module enabling evaluation of the prospective site data using a predetermined set of filtering criteria;
a modeling module enabling calculation of the value of at least one prospective site metric using the prospective site data wherein the at least one prospective site metric corresponds to at least one of the site performance criteria;
a scoring module enabling evaluation of the at least one prospective site metric using the predetermined set of filtering criteria and determination of whether the at least one prospective site meets the site performance criteria based on the evaluation of the prospective site data and the at least one prospective site metric; and
an output module enabling generation of a signal indicating the degree to which the at least one prospective site meets the site performance criteria.

18. The system of claim 17 wherein the user interface is a website.

19. The system of claim 17 wherein the site performance criteria comprises at least one of sales, market share, profit and market potential.

20. The system of claim 17 wherein the predetermined set of filtering criteria comprises at least one of geographic location, proximity to at least one type of business, site size, listed price, demographic information from the surrounding area and whether the site is located within a predetermined optimal market area.

21. A method for facilitating the purchase of commercial real estate comprising the steps of:
inputting site performance criteria and filtering criteria;
receiving prospective site data regarding at least one prospective site from at least one prospective seller;
evaluating the prospective site data using the filtering criteria;
receiving at least one prospective site metric based on the prospective site data;
evaluating the at least one prospective site metric using the filtering criteria;
receiving a determination of whether the at least one prospective site meets the site performance criteria based on the evaluation of the prospective site data and the at least one prospective site metric; and
determining whether to make an offer for the prospective site.
